(19) United States
(12) Patent Application Publication
(10) Pub. No.: US 2004/0001128 A1
(43) Pub. Date: Jan. 1, 2004

(54) Inkjet cartridge

(76) Inventor: Chao-Jung Hung, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/291,406

(22) Filed: Nov. 12, 2002

(30) Foreign Application Priority Data
Jun. 27, 2002 (TW) 091209914

(51) Int. Cl. B41J 2/175

(52) U.S. Cl. 347/86

(57) ABSTRACT

An inkjet cartridge includes a box having a transparent wall and an outlet is defined through an underside of the box. A top plate is connected to a top of the box and at least one inlet is defined through the top plate. A flange encloses the at least one inlet and protrudes from a top surface of the top plate. The user may check the ink in the box via the transparent wall of the box.

### FIELD OF THE INVENTION

The present invention relates to an inject cartridge having a transparent wall for observing the level of the ink in the cartridge and the inlets are enclosed by flanges extending from a surface of the top of the cartridge.

### BACKGROUND OF THE INVENTION

A conventional inkjet cartridge is shown in FIGS. 6 and 7 and generally includes a box 30 having an outlet 23 defined in an underside thereof and a top plate 32 is attached on a top of the box 30. A plurality of chambers 31 are defined in the box 30 and separated by plates and each chamber 31 receives a specific color of ink. The top plate 32 has several inlets 321 which are used to fill and refill ink in the box 30. The box 30 is made of dark plastic material that cannot be seen through so that when refill ink, the person who refills has no idea when the box 30 is full and to stop filling. The ink could flow out from the inlets 321 and enter into another chamber 31 via another inlet 321. It is to be noted that the colors of ink are different for a color inkjet cartridge in the three chambers 31 so that the overflowing of the ink may mix with another color of ink.

The present invention intends to provide a inkjet cartridge that the person who refills the ink in the cartridge may check the level of the ink via the transparent wall of the box and each inlet is enclosed by a flange to prevent the ink overflow to other inlets.

### SUMMARY OF THE INVENTION

In accordance with one aspect of the present invention, there is provided an inkjet cartridge which comprises a box having a transparent wall and an outlet is defined through an underside of the box. A top plate is connected to a top of the box and at least one inlet is defined through the top plate. A flange enclosing the at least one inlet protrudes from a top surface of the top plate.

The primary object of the present invention is to provide an inkjet cartridge that has transparent wall for conveniently checking the level of the ink and the inlets have flanges protruding from the top plate to as to prevent ink overflowing to another inlet.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the inkjet cartridge of the present invention;

FIG. 2 is an exploded view to show the inkjet cartridge of the present invention;

FIG. 3 shows an outlet defined in an underside of the inkjet cartridge of the present invention;

FIG. 4 shows the inkjet cartridge of the present invention is installed in a printer;

FIG. 5 shows the inkjet cartridge of the present invention has a single chamber;

FIG. 6 is a perspective view to show a conventional inkjet cartridge, and

FIG. 7 is an exploded view to show the conventional inkjet cartridge.

### DETAILED DESCRIPTION OF THE PREFERRED EMBODIMENT

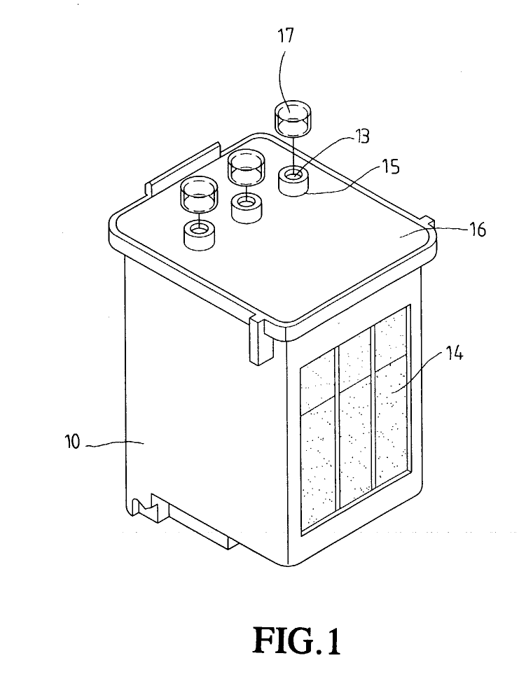

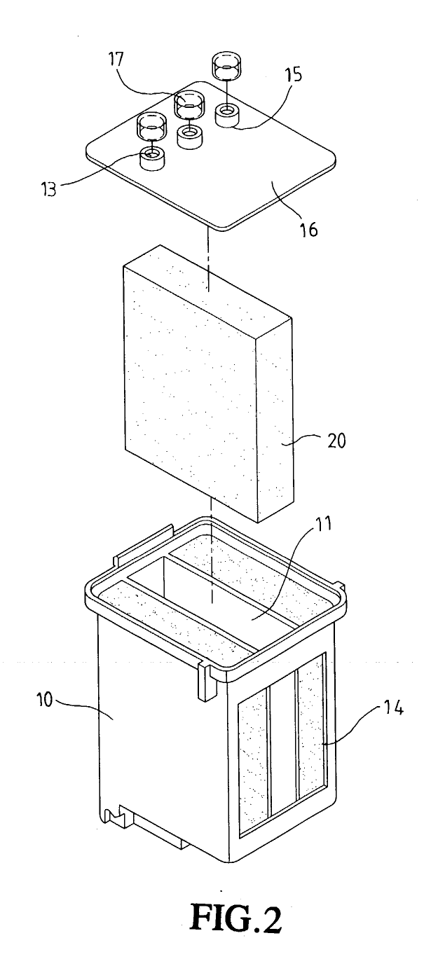

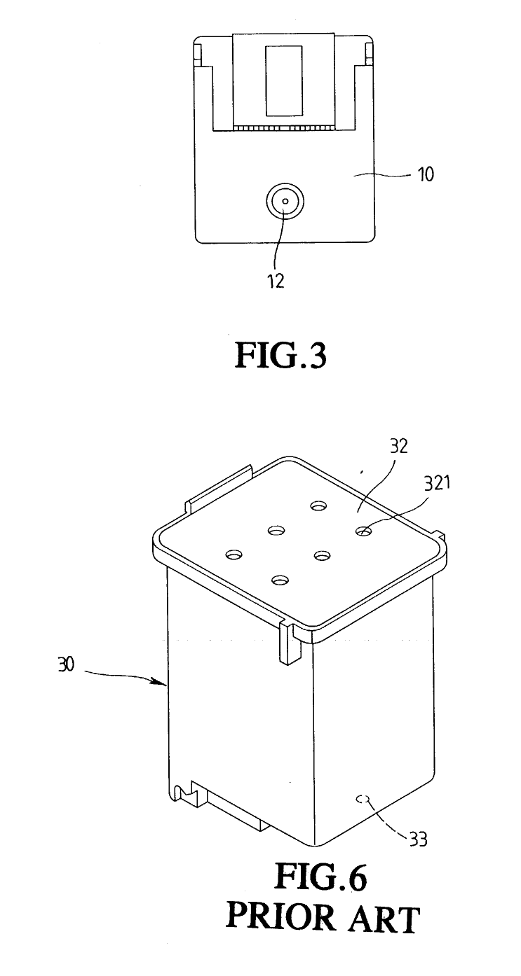

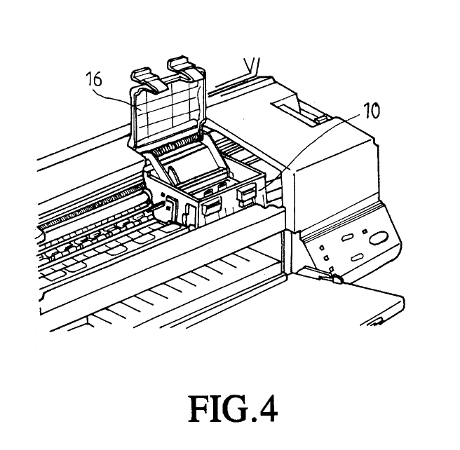

Referring to FIGS. 1 to 4, the inkjet cartridge of the present invention comprises a box 10 having a transparent wall 14 and an outlet 12 defined through an underside of the box 10. Three chambers 11 are defined in the box 10 and separated by plates in the box 10.

A top plate 16 is connected to a top of the box 10 and three inlets 15 are defined through the top plate 16. The three inlets 15 are in communication with the three chambers 11 respectively so as to fill different colors of ink in the three chambers 11 via the three inlets 15. A flange 13 encloses each of the three inlets 15 and protrudes from a top surface of the top plate 16. Each flange 13 is sealed by a cap 17. Each of the chambers 11 has a sponge 20 received therein so as to absorb the ink in the chamber 11 and the user may check the absorbing to know how much of the ink left in the chamber 11.

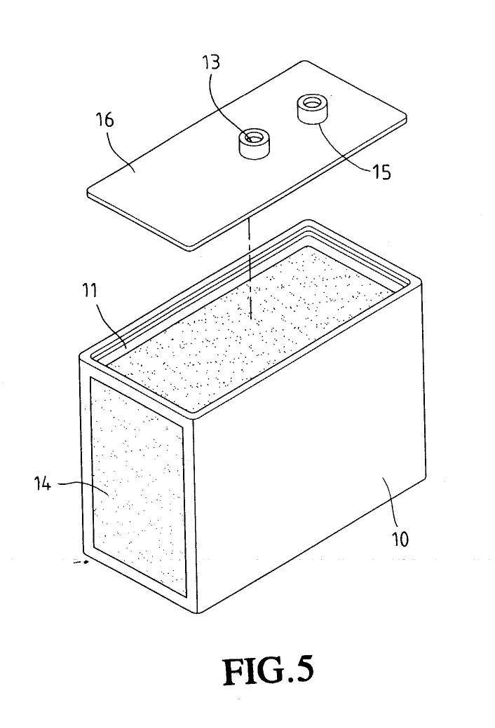

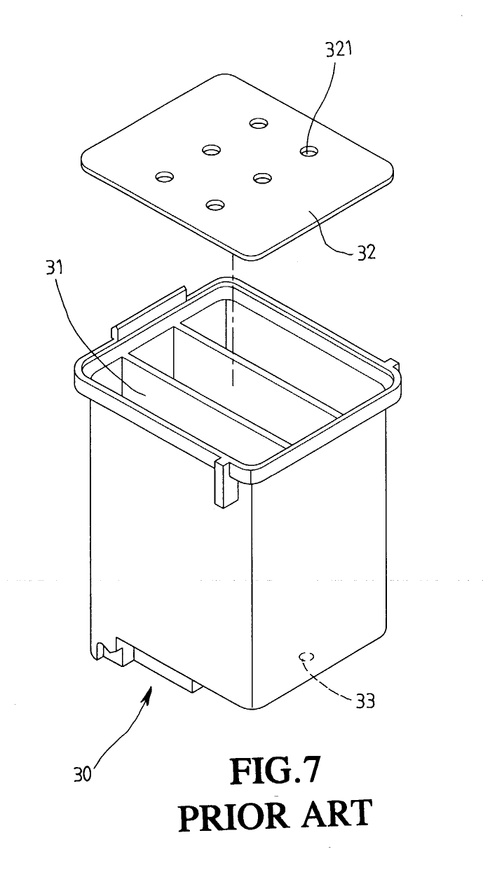

FIG. 5 shows a one-color cartridge wherein only one chamber 11 is defined in the box 10 and two inlets 15 are defined through the top plate 16.

The user can check the level of the ink in the box 10 via the transparent wall 14 of the box 10 and the flanges 13 enclosing the inlets 15 prevent the ink from overflowing into another inlet 15 when filling the ink.

While we have shown and described the embodiment in accordance with the present invention, it should be clear to those skilled in the art that further embodiments may be made without departing from the scope of the present invention.

What is claimed is:

1. An inkjet cartridge comprising:
a box having a transparent wall and an outlet defined through an underside of the box, a top plate connected to a top of the box and at least one inlet defined through the top plate, a flange enclosing the at least one inlet and protruding from a top surface of the top plate.

2. The inkjet cartridge as claimed in claim 1, wherein the box has a plurality of chambers separated by plates in the box.

3. The inkjet cartridge as claimed in claim 2, wherein each of the chambers has a sponge received therein.
